(19) United States
(12) Patent Application Publication
(10) Pub. No.: US 2026/0067857 A1
(43) Pub. Date: Mar. 5, 2026

(54) METHOD FOR RESOURCE SELECTION, AND DEVICE AND CHIP

(71) Applicant: GUANGDONG OPPO MOBILE TELECOMMUNICATIONS CORP., LTD., Dongguan (CN)

(72) Inventor: Shichang ZHANG, Dongguan, Guangdong (CN)

(21) Appl. No.: 19/386,204

(22) Filed: Nov. 11, 2025

Related U.S. Application Data
(63) Continuation of application No. PCT/CN2023/111798, filed on Aug. 8, 2023.

(51) Int. Cl. H04W 64/00; H04W 72/0446; H04W 72/25

(52) U.S. Cl. CPC H04W 64/00; H04W 72/0446; H04W 72/25

(57) ABSTRACT

Provided is a method for resource selection, which relates to the technical field of mobile communications. The method is performed by a terminal device, and includes: selecting at least one sidelink positioning reference signal (SL-PRS) resource from an SL-PRS resource set, wherein the SL-PRS resource is used to transmit an SL-PRS.

### CROSS REFERENCE TO RELATED APPLICATION

This application is a continuation n of International Application No. PCT/CN2023/111798, filed Aug. 8, 2023, the entire disclosure of which is incorporated herein by reference.

### TECHNICAL FIELD

Embodiments of the present disclosure relate to the field of communications, and in particular, relate to a method for resource selection, and a device and a chip thereof.

### RELATED ART

In a new radio sidelink (NR SL) system, further research and discussion are required on how to select SL positioning reference signal (SL-PRS) resources following an exclusion of resources by a terminal device.

### SUMMARY

Embodiments of the present disclosure provide a method and apparatus for resource selection, and a device and a storage medium therefor. The technical solutions are as follows:

According to some embodiments of the present disclosure, a method for resource selection is provided. The method is performed by a terminal device, and includes:
selecting at least one SL-PRS resource from an SL-PRS resource set, wherein the SL-PRS resource is used to transmit an SL-PRS.

According to some embodiments of the present disclosure, a terminal device is provided. The terminal device includes a processor and a memory, wherein the memory stores one or more computer programs, and the processor is configured to select at least one SL-PRS resource from an SL-PRS resource set, wherein the SL-PRS resource is used to transmit an SL-PRS.

According to some embodiments of the present disclosure, a chip is provided. The chip includes programmable logic circuitry and/or one or more computer instructions, wherein the chip, when running on a processor, is configured to select at least one SL-PRS resource from an SL-PRS resource set, wherein the SL-PRS resource is used to transmit an SL-PRS.

### BRIEF DESCRIPTION OF DRAWINGS

FIG. 1 is a schematic diagram of a network architecture according to some embodiments of the present disclosure;

FIG. 2 is schematic diagram of an association relationship between a PSSCH and a PSSCH in NR-V2X according to some embodiments of the present disclosure;

FIG. 3 is a schematic structural diagram of an NR system slot according to some embodiments of the present disclosure;

FIG. 4 is a schematic diagram of a second resource selection mode according to some embodiments of the present disclosure;

FIG. 5 is a schematic diagram of a comb size of an SL-PRS resource and an RE offset according to some embodiments of the present disclosure;

FIG. 6 is a schematic diagram of an interleaved resource block according to some embodiments of the present disclosure;

FIG. 7 is a schematic diagram of a frame structure based on interleaved resource blocks according to some embodiments of the present disclosure;

FIG. 8 is a schematic diagram of an RB set according to some embodiments of the present disclosure;

FIG. 9 is a schematic flowchart of a method for resource selection according to some embodiments of the present disclosure;

FIG. 10 is a schematic diagram of an OFDM symbol group according to some embodiments of the present disclosure;

FIG. 11 is a schematic block diagram of an apparatus for resource selection according to some embodiments of the present disclosure; and

FIG. 12 is a schematic structural diagram of a terminal device according to some embodiments of the present disclosure.

### DETAILED DESCRIPTION

For clearer descriptions of the objectives, technical solutions, and advantages of the present disclosure, the embodiments of the present disclosure are described in detail herein after in combination with the accompanying drawings.

The network architecture and service scenarios described in the embodiments of the present disclosure are intended to illustrate more clearly rather than to limit the technical solutions according to the embodiments of the present disclosure. Those skilled in the art understand that with evolution of the network architecture and emergence of new service scenarios, the technical solutions according to the embodiments of the present disclosure are also applicable to addressing similar technical problems.

FIG. 1 is a block diagram of a network architecture according to some embodiments of the present disclosure. The network architecture involves a core network 11, an access network 12, and a terminal device 13.

The core network 11 includes a plurality of core network devices. Each of the core network devices mainly functions to provide user connectivity, user management, and service bearing, and is determined as a bearer network for providing an interface to an external network. For example, in a 5^{th} generation (5G) NR system, the core network includes an access and mobility management function (AMF) entity, a user plane function (UPF) entity, a session management function (SMF) entity, and other devices.

The access network 12 includes several access network devices 14. The access network in the 5G NR system is also referred to as a new generation-radio access network (NG-RAN). Each of the access network devices 14 is a device deployed in the access network 12 and configured to provide a wireless communication function for the terminal device 13. The access network devices 14 include various types of macro base stations, micro base stations, relay stations, access points, and the like. In systems using different radio access technologies, the devices with the functionality of the access network device have different names, for example, gNodeBs or gNBs in 5G NR systems. With the evolution of communications technology, the term “access network device” may vary. For ease of description, the devices providing the wireless communication function for the terminal device 13 are collectively referred to as the access network device in the embodiments of the present disclosure.

Generally, a plurality of terminals are provided. One or more terminal devices 13 may be deployed in a cell managed by each of the access network device 14. The terminal devices 13 include various handheld devices, vehicle-mounted devices, wearable devices, computing devices or other processing devices connected to wireless modems, various forms of user equipments (UEs), mobile stations (MSs), and other devices with the wireless communication function. For ease of description, the devices are collectively referred to as the terminal device. The access network device 14 and the core network device communicate with each other using the air interface technology, such as an NG interface in a 5G NR system. The access network device 14 and the terminal device 13 communicate with each other using the air interface technology, such as a Uu interface. The terminal device in the embodiments of the present disclosure is also referred to as a UE, and the terminal device and the UE have the same meaning.

The terminal device 13 and the terminal device 13 (for example, the vehicle-mounted device and other devices (e.g., other vehicle-mounted devices, mobile phones, or road side units (RSU)) communicate with each other via a direct communication interface (for example, a ProSe Communication 5 (PC5) interface), and the communication link established over the direct communication interface is collectively referred to as a direct link or an SL. SL communication indicates that transmission of communication data between the terminal devices is achieved over the SL, which is different from the traditional cellular system in which communication data is received or transmitted via the access network device. Thus, the SL communication has the characteristics of short delay and low overhead, and is suitable for communication between two terminal devices at proximate geographic locations (e.g., a vehicle-mounted device and other peripheral devices at near geographic locations). It should be noted that FIG. 1 is only illustrated using the vehicle-to-vehicle communication in the V2X scenario as an example, and the SL technology is applicable to a scenario where various terminal devices directly communicate with each other. In other words, the terminal device in the present disclosure is any device that implements communication using the SL technology.

The “5G NR system” in the embodiments of the present disclosure is also referred to as a 5G system or an NR system, and those skilled in the art understand the meaning. The technical solutions according to the embodiments of the present disclosure are applicable to the 5G NR system and evolved systems of the 5G NR system.

Before description of the technical solutions according to the present disclosure, some background technical knowledge relevant to the present disclosure is introduced and explained first. The following related technologies, as optional solutions, may be randomly combined with the technical solutions according to the embodiments of the present disclosure, which fall within the scope of protection of the embodiments of the present disclosure. The embodiments of the present disclosure include at least part of the following content.

### 1. Determination of Frequency-Domain Resources in NR-V2X

The frequency-domain resources within an NR-V2X resource pool are similar to the frequency-domain resources in long-term evolution; the frequency-domain resources are allocated at a sub-channel granularity. A set of possible numbers of resource blocks contained in one sub-channel is {10, 12, 15, 20, 50, 75, 100}, wherein the size of the smallest sub-channel is 10 physical resource blocks (PRBs), which is far greater than the size (four PRBs) of the smallest sub-channel in LTE-V2X. The main reason is that in NR-V2X, the frequency-domain resources of a physical sidelink control channel (PSCCH) are within a first sub-channel of physical sidelink shared channel (PSSCH) associated with the frequency-domain resources. That is, the frequency-domain resources of the PSCCH are smaller than or equal than the size of one sub-channel of the PSSCH, whereas time-domain resources of the PSCCH occupy two or three OFDM symbols. In a case where a configured size of the sub-channels is relatively small, fewer PSCCH available resources are present, coding rate is improved, and detection performance of PSCCHs is degraded. In NR-V2X, the sizes of both a PSSCH sub-channel and the frequency-domain resources of the PSCCH are separately configured. However, the configuration needs to ensure that the frequency-domain resources of the PSCCH are smaller than or equal the size of the sub-channels of the PSSCH. The following parameters in NR-V2X resource pool configuration information are used to determine the frequency-domain resources of the PSCCH and the PSCCH resource pool:
sl-SubchannelSize, indicating the number of consecutive PRBs contained in one sub-channel within the resource pool, and a set of possible values is {10, 12, 15, 20, 25} PRBs;
sl-NumSubchannel, indicating the number of sub-channels contained within the resource pool;
sl-StartRB-Subchannel, indicating a start PRB index of the first subchannel within the resource pool;
sl-RB-Number, indicating the number of consecutive PRBs contained within the resource pool; and
sl-FreqResourcePSCCH, indicating a resource size of the PSCCH, and a set of possible values is {10, 12, 15, 20, 25}.

In a case where the UE determines the resource pool for PSSCH transmission or reception, the frequency resources contained in the resource pool are sl-NumSubchannel consecutive sub-channels start the PRBs indicated by sl-StartRB-Subchannel. In a case where the final number of PRBs contained in the sl-NumSubchannel consecutive sub-channels is less than the number of PRBs indicated by sl-RB-Number, and the remaining PRBs are not allowed to be used for PSSCH transmission or reception.

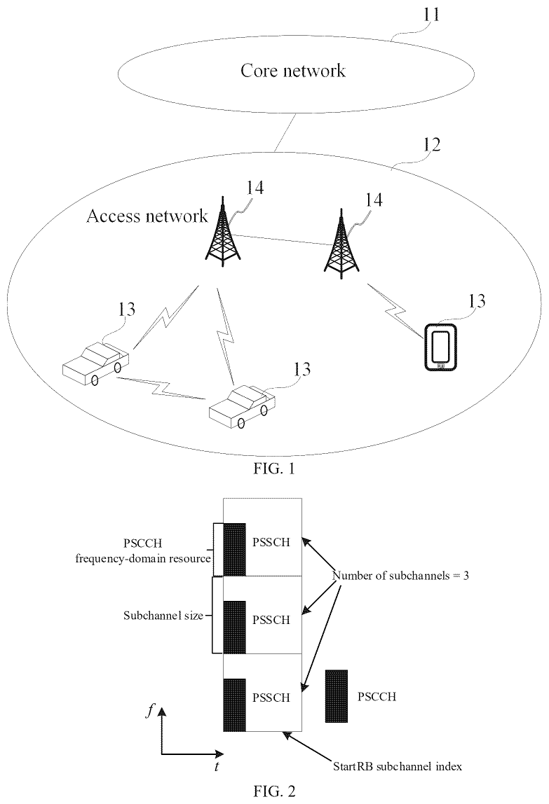

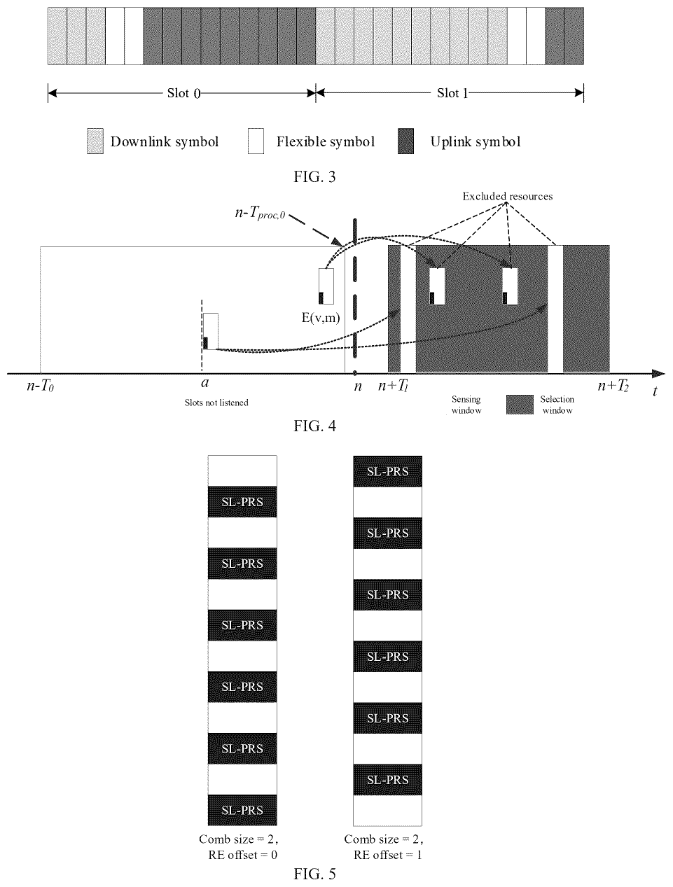

In NR-V2X, the PSCCH is aligned with a start position in the frequency-domain of the first sub-channel of the PSSCH associated with the PSCCH. In this way, each start position of the PSSCH sub-channel is a possible start position in the frequency-domain for the PSCCH. As illustrated in FIG. 2, a frequency-domain range of the PSCCH and the resource pool of the PSSCH may be determined based on the above parameters.

In NR-V2X, sidelink control information used by the PSCCH related to carrying and resource sensing includes:
a priority of a scheduled transmission;
a frequency-domain resource allocation, indicating the number of frequency-domain resources of the PSSCH in a current slot scheduled by the PSCCH, and the number and the start positions of the frequency-domain resources of at most two reserved retransmission resources;
time-domain resource allocation, indicating positions in the time-domain of at most two retransmission resources;
a reference signal pattern of the PSSCH;
a second-order sidelink control information (SCI) format;
a second-order SCI code rate offset;
the number of PSSCH demodulation reference signal ports;
a modulation and coding scheme (MCS);
an MCS index indication;
the number of physical sidelink feedback channel symbols;
a resource reservation period, reserving a resource transmitted by another transport block (TB) in a next period, wherein in a case where an inter-TB resource reservation is not activated in a current resource pool configuration, bit field information for the resource reservation period is not present; and
reserved bits: 2 to 4 bits, wherein the specific number of reserved bits is configured by a network or is pre-configured.

As the PSSCH is always transmitted within one slot along with a scheduled PSSCH, and the start position of the PRBs occupied by the PSCCH is the start position of the first sub-channel of the scheduled PSSCH, a time-frequency domain start position of the scheduled PSSCH is not clearly specified in an SCI format 1-A.

### 2. Determination of Time-Domain Resources (Slots) in NR-V2X

In NR-V2X, transmission of the PSCCH/PSSCH is at a slot level. That is, only one PSCCH/PSSCH is transmitted in a slot, a plurality of PSCCHs/PSSCHs are not transmitted in a slot in a time-division multiplexing (TDM) mode, and PSCCHs/PSSCHs between different users are multiplexed in a slot in a frequency-division multiplexing (FDM) mode. The time-domain resources of the PSSCH in NR-V2X are at a slot granularity. However, unlike in LTE-V2X where the PSSCH occupies all the time-domain symbols in a sub-frame, the PSSCH in NR-V2X may occupy some symbols in a slot. The main reason is that, in the LTE system, uplink transmission and downlink transmission are also at a sub-frame granularity. Therefore, sidelink transmission is also at the sub-frame granularity (special sub-frames in the TDD system are not used for sidelink transmission). In the NR system, a flexible slot structure is adopted, i.e., both the uplink symbol and the downlink symbol are located in a slot. Thus, more flexible scheduling is achieved, and the latency is reduced. A typical sub-frame of an NR system is illustrated in FIG. 7. The slot includes downlink (DL) symbols, uplink (UL) symbols, and flexible symbols. The downlink symbols are located at the beginning of the slot, the uplink symbols are located at the end of the slot, flexible symbols are located between the downlink symbols and uplink symbols, and the number of various symbols in each slot is configurable.

The sidelink transmission system shares the carrier with the cellular system. In this case, the uplink transmission resources of the cellular system are used for the sidelink transmission. For NR-V2X, in a case where sidelink transmission needs to occupy all the time-domain symbols in a slot, the network needs to configure a slot with all uplink symbols for the sidelink transmission, which greatly affects the uplink and downlink data transmission of the NR system, and reduces the performance of the system. Therefore, in NR-V2X, part of the time-domain symbols in a slot are used for the sidelink transmission, i.e., part of the uplink symbols in a slot are used for the sidelink transmission. In addition, as automatic gain control (AGC) symbols and guard period (GP) symbols are included in the sidelink transmission, and the number of symbols available for valid data transmission is even smaller and resource utilization is low upon removal of the AGC symbols and the GP symbols in a case where the number of uplink symbols available for sidelink transmission is small. Therefore, in NR-V2X, the sideline transmission occupies at least seven time-domain symbols (including the GP symbol). In a case where the sidelink transmission system uses a proprietary carrier, the sidelink transmission system does not share transmission resources with other systems, and all symbols in the slot are configured for sidelink transmission.

As mentioned above, in NR-V2X, the start point and the length of time-domain symbols for sidelink transmission in a slot are configured based on a position of a start symbol sl-StartSymbol and the number of symbols sl-LengthSymbols. The last symbol in the time-domain symbols for sidelink transmission is used as the GP. The PSSCH and the PSCCH only use the remaining time-domain symbols. However, in a case where the PSFCH transmission resources are configured in a slot, the PSSCH and the PSCCH are not allowed to occupy the time-domain symbols for PSFCH transmission, the AGC and the GP symbols preceding the time-domain symbols.

In the NNR-V2X system, the time-domain resources of the resource pool are also indicated by a bitmap. Due to the flexible slot structure in the NR system, the length of the bitmap is expanded, and the supported length range of the bit bitmap is [10:160]. The method for determining the position of the slot belonging to the resource pool in a system frame number (SFN) periodicity using the bitmap in NNR-V2X and the method in LTE-V2X are the same and differ in that:
The total number of slots in an SFN periodicity is 10240×2^{μ}, wherein the parameter u is related to a size of a sub-carrier interval.
In a case where at least one of time-domain symbols Y, Y+1, Y+2, . . . , Y+X−1 in a slot is not configured as an uplink symbol by a TDD-UL-DL-ConfigCommon signaling of the network, the slot may not be used for sidelink transmission, wherein Y and X represent sl-StartSymbol and sl-LengthSymbols respectively.

### Specifically,

In S1, slots that do not belong to the resource pool in the SFN periodicity are removed. The slots include synchronous slots and slots that may not be used for sidelink transmission, and remaining slots are represented as a remaining slot set and are renumbered as (l₀, l₁, . . . , l_{(10240×2}_{^{μ}}_{-N}_{_{S_SSB}}_{-N}_{_{nonSL}}₋₁₎).
N_{S_SSB} represents the number of synchronous slots in an SFN periodicity, and the synchronization slot is determined based on a synchronization-related configuration parameter and is related to a periodicity for transmitting a synchronization signal block (SSB), the number of transmission resources of the SSB configured in the periodicity, and the like;
N_{nonsL} represents the number of slots in an SFN periodicity that do not conform to the start point of the uplink symbol and number configuration. In a case where at least one of time-domain symbols Y, Y+1, Y+2, . . . , Y+X−1 in a slot is not semi-persistently configured as an uplink symbol, the slot may not be used for sidelink transmission, wherein Y and X represent sl-StartSymbol and sl-LengthSymbols respectively.
In S2, the number of reserved slots and corresponding time-domain positions are determined.
In a case where the number of slots in the remaining slot set is divided evenly by a length of the bitmap, the number of reserved slots and the corresponding time-domain positions are determined. Specifically, in a case where a slot lᵣ (0≤r<10240×2^{μ}−N_{S_SSB}−N_{nonSL}) satisfies the following conditions, the slot is a reserved slot.

$$r = ⌊ \frac{m \cdot ( 10240 \times {2}^{μ} - {N}_{S \_ SSB} - {N}_{n o n S L} )}{{N}_{r e s e r v e d}} ⌋ ;$$

$${N}_{r e s e r v e d} = ( 102 \; 40 \times {2}^{μ} - {N}_{S \_ SSB} - {N}_{n o n S L} ) mod {L}_{bitmap} , and {N}_{reserved}$$

represents the number of reserved slots, and L_{bitmap} represents the length of the bitmap, wherein m=0, . . . , N_{reserved}−1.
In S3, the reserved slots are removed from the remaining slot set. The remaining slot set is represented as a logical slot set. All slots in the slot set are available for the resource pool, and are renumbered as

$$( {t}_{0}^{S L} , {t}_{1}^{S L} , … , {t}_{{T}_{max} - 1}^{S L} ) ,$$

$$wherein {T}_{max} = 10240 \times {2}^{μ} - {N}_{S \_ SSB} - {N}_{n o n S L} - {N}_{r e s e r v e d} .$$

In S4, the slots belonging to the resource pool in the logical slot set are determined based on the bitmap.
The bitmap in the resource pool configuration information is (b₀, b₁, . . . , b_{L}_{_{bitmap}}₋₁). For the slot

$${t}_{k}^{SL} ( 0 \leq k < ( 10240 \times {2}^{μ} - {N}_{S \_ SSB} - {N}_{nonSL} - {N}_{reserved} ) )$$

in the logical slot set, in a case where b_{k′}=1, the slot belongs to the resource pool, wherein k′=k mod L_{bitmap}.
In S5, the slots determined in S4 that belong to the resource pool are renumbered as

$${{t}^{′}}_{i}^{SL} , wherein i ∈ \{ 0 , 1 , … , {{T}^{′}}_{max} - 1 \} , and {{T}^{′}}_{max}$$

represents the number of slots in the resource pool.

### 3. Second Resource Selection Mode in NR-SL

In a resource allocation mode 2, an UE upper layer may request a UE physical layer to determine a resource subset from which the UE upper layer selects resources for PSSCH/PSCCH transmission. To trigger this process, the UE upper layer provides the following parameters related to PSSCH/PSCCH transmission to the physical layer:
a resource pool of the resource subset;
physical layer priority, prio_{TX};
a remaining latency estimated PDB;
the number of sub-channels used for PSSCH/PSCCH transmission within a slot, L_{subCH}; and
optionally, a resource reservation period P_{rsvp_TX} in milliseconds (ms).

High level configuration parameters affecting the determination process of the resource subset are described as follows:
sl-SelectionWindowList, configuring a minimum value of T_{2 min} regarding different prio_{TX}, wherein T_{2 min} is set to a value configured by the sl-SelectionWindowList regarding prio_{TX};
sl-ThreshPSSCH-RSRP-List, configuring an RSRP threshold associated with each (pᵢ, pⱼ) combination, wherein pᵢ is a priority indicated in a received SCI, and pⱼ=prio_{TX}.
sl-RS-ForSensing, instructing the UE to use a PSSCH-RSRP or PSCCH-RSRPS measurement result to perform resource exclusion;
sl-ResrouceReservedPeriodList, indicating available resource reservation period within a resource pool;
sl-SensingWindow, indicating a start point T₀ of a resource sensing window, wherein T₀ is defined as a number slots associated with the sl-SensingWindow milliseconds;
sl-TxPercentageList, configuring a ratio X of the remaining resources following a resource exclusion. Regarding prio_{TX}, X is defined as sl-TxPercentageList (prio_{TX}); and
sl-PreemptionEnable, indicating whether a resource preemption is activated in a resource pool, and in a case where the resource preemption is activated, sl-PreemptionEnable indicates a value of the resource preemption priority prioₚᵣₑ;
In a case where the resource reservation period is provided by the UE upper layer, Pᵣₛᵥₚ_{_{TX}} is converted to a number of logic slot

$${P}_{{rsvp}_{TX}}^{′} .$$

As illustrated in FIG. 4, the steps for determining the resource subset by the UE physical layer are as follows:
1) A candidate single-slot resource R_{x,y} is defined as consecutive L_{subCH} sub-channels within a slot

$${{t}^{′}}_{y}^{SL} ,$$

and an index of the sub-channel is x+j, wherein j=0, . . . , L_{subCH}−1. The UE assumes that any L_{subCH} sub-channel within a time range [n+T₁, n+T₂] is associated with one single slot resource.
   0≤T₁≤T_{proc,1}, and specific values are determined by the UE in practice. In a case where a subcarrier spacing is selected from a set of values consisting {15, 30, 60, 120} kHz, T_{proc,1} is the number of slots selected from a set of values consisting {3, 5, 9, 17} respectively.
   In a case where T_{2 min} is less than a remaining packet delay budget (PDB) in terms of slots, T_{2 min}≤T₂≤PDB and specific values are determined by the UE in practice. Otherwise, T₂ equals the PDB, wherein the PDB is indicated by the UE upper layer. T_{2 min} is selected from a set of values consisting {1, 5, 10, 20}×2^{μ} number of slots, wherein μ=0, 1, 2, 3. Regarding the case where the subcarrier spacing is selected from a set of values {15, 30, 60, 120} kHz, the UE determines T_{2 min} from the set of values based on the priority prio_{TX} of its own data pending for transmission.
   A total number of candidate single-slot resources is Mₜₒₜₐₗ.
2) A resource sensing window is defined as a slot within a range

$$[ n - {T}_{0} , n - {T}_{proc , 0}^{SL} ) ,$$

wherein the definition of T₀ is the same as above, and in a case where the subcarrier spacing is selected from a set of values {15, 30, 60, 120} kHz, T_{proc,1} is the number of slots selected from a set of values consisting {1, 1, 2, 4} respectively. Unless the UE is currently performing transmission on some slots, the UE listens for slots belonging to a sidelink resource pool within the resource sensing window.
3) A parameter Th(pᵢ,pⱼ) is set as an i^{th} value configured by the sl-ThreshPSSCH-RSPS-List, wherein i=pᵢ+(pⱼ−1)*8.
4) A set S_{A} is initialized to all candidate single-slot resources.
5) The UE excludes the candidate resources R_{x,y} within S_{A} in response to satisfying the following conditions:
   the UE did not listen to slot

$${{t}^{′}}_{m}^{SL}$$

in 2); and
   y=m+P for any number of logic slots P associated with one resource reservation period allowed within the resource pool configured by the sl-ResrouceReservePerdioList.
6) The UE excludes the candidate resources R_{x,y} within S_{A} in response to satisfying the following conditions:
   a) The UE receives the SCI format 1-A at slot

$${{t}^{′}}_{m}^{SL} ,$$

wherein the “resource reservation period field” (if present) and “priority” field are indicated by P_{rsvp_RX} and prio_{TX} respectively.
   b) An RSRP measured for the received SCI is higher than Th(prio_{RX}, prio_{TX}).
   c) The received SCI format 1-A at slot

$${{t}^{′}}_{m}^{SL}$$

and a research PSSCH resource overlaps with

$${R}_{x , y + j \times {P}_{rsvp \_ TX}^{′}} ,$$

or in a case where the “resource reservation period” is present in the received SCI format 1-A, it is posited that an SCI indicator of a same format received at slot

$${t}_{m + q \times {P}_{rsvp \_ RX}^{′}}^{SL}$$

and a reserve resource overlaps with

$${R}_{x , y + j \times {P}_{rsvp \_ TX}^{′}} , wherein q = 1 , 2 , … , Q , \\ j = 0 , 1 , … , {C}_{resel} - 1. Here , {P}_{rsvp \_ RX}^{′}$$

is the number of logic slots converted from P_{rsvp_RX}. In a case where

$${P}_{rsvp \_ RX} < {T}_{scal} , and {n}^{′} - m \leq {P}_{rsvp \_ RX}^{′} , Q = ⌈ \frac{{T}_{scal}}{{P}_{rsvp \_ RX}} ⌉ ,$$

to a set

$$( {{t}^{′}}_{0}^{SL} , {{t}^{′}}_{1}^{SL} , {{t}^{′}}_{2}^{SL} , ... ) , {t}_{{n}^{′}}^{SL} = n , otherwise {t}_{{n}^{′}}^{SL}$$

becomes a first slot belonging to the set

$$( {{t}^{′}}_{0}^{SL} , {{t}^{′}}_{1}^{SL} , {{t}^{′}}_{2}^{SL} , ... )$$

following slot n; otherwise Q=1. T_{scal} is a value in milliseconds converted from T₂. Cᵣₑₛₑₗ is the number of PSSCH transmission opportunities to be selected.

$$( {{t}^{′}}_{0}^{SL} , {{t}^{′}}_{1}^{SL} , {{t}^{′}}_{2}^{SL} , ... )$$

indicates a set of logical slots contained in the resource pool.
7) In a case where the number of single-slot resources in a set S_{A} is less than X·Mₜₒₜₐₗ, the UE increases a value of Th(pᵢ,pⱼ) by 3 dB and performs step 4).

The UE physical layer reports S_{A} to a medium access control (MAC) layer.

### 4. Positioning Based on the Downlink Link

In the positioning based on the downlink link, downlink positioning reference signal (DL-PRS) configuration of at most four positioning frequency layers are provided for a UE. A parameter structure of each positioning frequency layer is provided with following configuration parameters of the PRS:
a subcarrier spacing of the PRS;
a length of a cyclic prefix (CP) of the PRS;
a bandwidth of frequency-domain resources of the PRS, a value of the parameter is the number of PRBs allocated to the PRS. A minimum bandwidth of the resources of the PRS is 24 PRBs with a granularity of four PRBs, and a maximum bandwidth is 272 PRBs;
a start frequency position of the frequency domain of the resources of the PRS, defining an index number of a start PRB assigned to the PRS in the frequency domain. The index number of PRBs is defined relative to Point A of the PRS;
a frequency-domain reference point (Point A) of the PRS; and
a comb size of the PRS is comb-N.

The PRS parameters configured in each positioning frequency layer are applicable to all PRS resources in the positioning frequency layer. That is, in a positioning frequency layer, all PRSs from a plurality of different transmission and reception points (TRPs) adopt the same subcarrier interval, the same length of the CP, and the same comb size, are transmitted on the same frequency sub-band, and occupy exactly the same bandwidth. In this way, the UE simultaneously receives and measures PRSs from a plurality of different TRPs at the same frequency point.

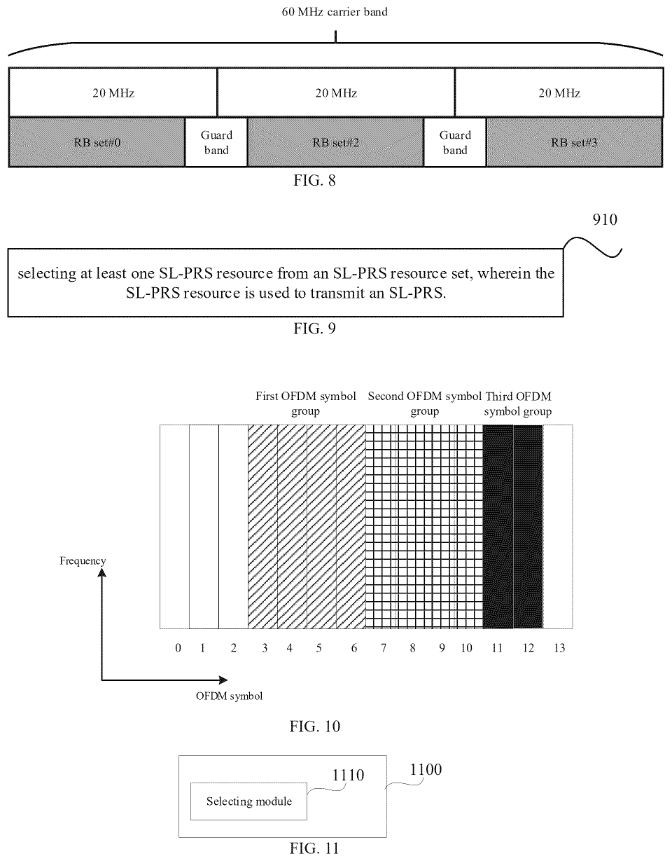

The parameters of the TRP layer include an identifier (ID) parameter for uniquely identifying the positioning TRP, a physical cell ID of the TRP, and an NR cell global ID (NCGI) of the TRP, and an absolute radio frequency channel number (ARFCN) of the TRP. At most two DL-PRS resource sets are configured in each TRP layer. The parameters of the layer of the DL-PRS resource set are configured with the following parameters applicable to all the DL-PRS resources in the resource set:
An ID of a DL-PRS resource set (nr-DL-PRS-ResourceSetID).
A transmission periodicity and a slot offset of the DL-PRS (dl-PRS-Periodicity-and-ResourceSetSlotOffset), defining time-domain transmission behaviors of all DL-PRS resources in the DL-PRS resource set. A minimum configurable transmission periodicity of the DL-PRS is 4 milliseconds, and a maximum transmission periodicity is 10240 milliseconds. The configuration of the DL-PRS supports flexible subcarrier intervals, including 15 KHz, 30 KHz, 60 KHz, and 120 KHz. In different subcarrier intervals, ranges of the configurable DL-PRS transmission periodicity are the same. FIG. 8 is a schematic diagram with a comb size 2 and RE offsets 0 and 1.
A repetition factor of the DL-PRS resources (dl-PRS-ResourceRepetitionFactor), defining the number of retransmissions of a PRS resource in each PRS periodicity. The retransmission of the same DL-PRS resource is used by the UE to collect the energy of DL-PRSs that are transmitted several times to increase a coverage distance of the DL-PRS and a positioning accuracy. In the FR2 system, the retransmission of the DL-PRS resources is used by the UE as a receive beam sweeping operation. The UE uses different receive beams to receive the retransmission of the same DL-PRS resource to find an optimal TRP transmit beam to match the UE receive beam. In addition, the retransmission of the DL-PRS resource increases an overhead of the PRS. In the specification of 3GPP NR-R16, a repetition value of the DL-PRS resources is any one of 1, 2, 4, 6, 8, 16, and 32.
A time interval for retransmission of the DL-PRS resource (dl-PRS-ResourceTimeGap), defining the number of slots between two contiguous retransmissions of the same PRS resource.
Muting configuration of the DL-PRS, defining that a DL-PRS is not transmitted on an allocated time-frequency resource (referred to as muting). Muting refers to the fact that the DL-PRS is not transmitted on all allocated time-frequency resources, and is intentionally not transmitted on a specified time-frequency resource. Muting is designed to avoid collision with other signals (for example, the SSB) and avoid interference between signals from different TRPs. For example, transmission of the DL-PRS of a TRP is intentionally suspended for some instants such that the UE may receive a DL-PRS from a remote TRP. The muting operation of the PRS is described in detail hereinafter, which is not elaborated herein.
The number of OFDM symbols occupied by the DL-PRS resource (dl-PRS-NumSymbols), defining the number of OFDM symbols allocated to a DL-PRS resource in a slot.

As mentioned above, all parameters configured in the configuration layer of a DL-PRS resource set are applicable to all DL-PRS resources in the resource set. Therefore, all DL-PRS resources in the same DL-PRS resource set are transmitted at the same periodicity with the same number of repetitive transmissions and occupy the same number of OFDM symbols.

Each DL-PRS resource is configured with the following parameters:
an ID of a DL-PRS resource (nr-DL-PRS-ResourceID);
a sequence ID of the DL-PRS (dl-PRS-SequenceID);
a start frequency-domain resource unit offset of the DL-PRS (dl-PRS-CombSizeN-AndReOffset), defining a frequency-domain resource unit offset value used for resource mapping of the DL-PRS resource to a first allocated OFDM symbol in a slot; wherein based on the parameter and the relative offset value specified in TS38.211, the UE determines the frequency-domain resource unit offset values used for resource mapping to each OFDM symbol;
a resource slot offset of the DL-PRS (dl-PRS-ResourceSlotOffset), defining a slot offset relative to the DL-PRS resource set, wherein the slot position of each DL-PRS resource is determined based on the parameter;
an OFDM symbol offset of the DL-PRS (dl-PRS-ResourceSymbolOffset), defining a time-frequency resource allocation position of a DL-PRS resource in a slot, and indicating a start OFDM symbol index number in the slot; and
quasi co-location (QCL) information of the DL-PRS (dl-PRS-QCL-Info), providing the QCL information of the DL-PRS.

### 5. Sidelink Over Unlicensed Spectrum (SL-U)

In the SL-U, sidelink transmission needs to satisfy specific regulatory requirements, for example, a minimum occupied channel bandwidth (OCB) and a maximum power spectral density (PSD). For the OCB requirement, in a case where the UE transmits data over the channel, the OCB should be no less than 80% of a bandwidth of a channel; and for the maximum PSD requirement, the transmit power of the UE per 1 MHz should be no greater than 10 dBm. An interlaced resource block (IRB) structure is used in the SL-U to satisfy OCB and PSD regulatory requirements. An IRB includes N discrete RBs in the frequency domain, M IRBs are included in a frequency band range, and the number of RBs in an m^{th} IRB is any one of {m, M+m, 2M+m, 3M+m, . . . }.

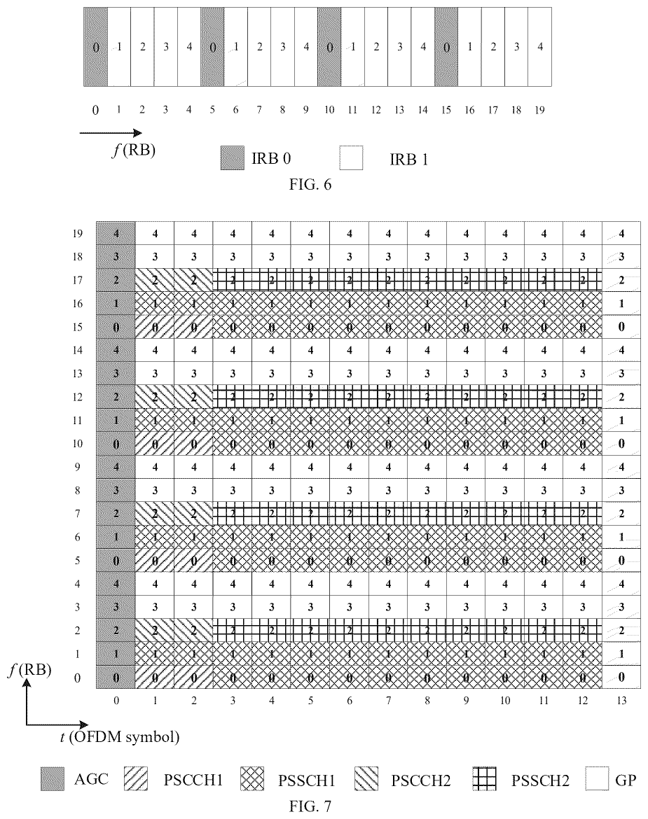

As illustrated in FIG. 6, the system bandwidth includes 20 RBs and five IRBs (that is, M=5), and each IRB includes four RBs (that is, N=4). The frequency-domain interval of two adjacent RBs belonging to the same IRB are the same, i.e., five RBs. The numbers in the boxes in the drawing represent the IRB index.

In the SL-U system, in a case where a resource allocation granularity is an IRB, the channels, for example, the PSCCH and the PSSCH of the SL-U system are set based on the IRB structure. In this case, the frame structure of the SL-U system is illustrated in FIG. 7, and the numbers in the boxes in the drawing represent the IRB index. FIG. 7 is a schematic diagram of a frame structure of a slot that only includes a PSCCH and a PSSCH and does not include a PSFCH. The bandwidth illustrated includes 20 RBs, and five IRB resources are configured (that is, M=5). Each IRB resource includes four RBs, and the numbers in the boxes in the illustration represent the IRB index. In FIG. 7, the system configures the PSCCH to occupy one IRB resource and two OFDM symbols in the time-domain. The PSSCH takes an IRB as the granularity. The first symbol in the slot is an AGC symbol, and a last symbol is a GP symbol. In the illustration, PSSCH 1 occupies IRB #0 and IRB #1, and corresponding PSCCH 1 occupies IRB #0; and PSSCH 2 occupies IRB #2, and corresponding PSCCH 2 also occupies IRB #2. It should be noted that for the sake of simplification, resources occupied by the second-stage SCI and resources occupied by the PSCCH DMRS and the PSSCH DMRS are not illustrated.

In the SL-U, the UE accesses the channel via listen before talk (LBT). The LBT takes a granularity of 20 MHz in the frequency-domain. And each 20 MHz is referred to as an RB set. a carrier includes a plurality of RB sets, and a GP is present between RB sets, as illustrated in FIG. 8.

In the SL-U, the UE needs to perform LBT first, and may access the channel only upon a successful LBT. However, a time for the UE to perform the LBT is indefinite. In a case where the UE is only able to start transmission from one start point of a slot, the UE may miss a transmission opportunity due to not completing the LBT. Therefore, in the SL-U, an additional transmission start point is added within a slot, i.e., multi-start point transmission. For example, the additional start point is the third or fourth OFDM symbol in the slot.

### 6. Positioning Based on Sidelink

In 3GPP R-17, 3GPP RAN researches “NR positioning enhancement” and “scenarios and requirements of NR position cases within coverage, partially within coverage, and beyond coverage.” The “scenarios and requirements of NR position cases within coverage, partially within coverage, and beyond coverage” focuses on V2X and public safety cases. Furthermore, the 3GPP SAI working group has also formulated the requirements of “ranging-based services” and established the positioning accuracy requirements for the Industrial Internet of things (IIoT) beyond a coverage. 3GPP needs to research and develop sidelink positioning solutions to support cases, scenarios and requirements identified in the activities.

The 3GPP completed the feasibility and performance research of positioning based on the SPRS in the early stage of Rel-18 to improve the positioning accuracy, especially positioning of a UE beyond a cellular network coverage. Next, the objective is to standardize the solution based on sidelink positioning (including ranging/orientation) in the NR system.

In the sidelink, different UEs transmits the SL-PRS occupying different time-frequency resources, and how to multiplex the PSCCH indicating transmission of SL-PRS is an unsolved problem. Regarding this issue, some embodiments of the present disclosure provide a solution elaborated in detail hereinafter. Additionally, in the context of the present disclosure, all indexes/numbers are counted from 0 unless otherwise specified.

In the second resource selection mode in NR SL, upon completion of the resource exclusion and reporting the resource subset by the physical layer of the UE to the MAC layer of the UE, how the MAC layer of the UE should select SL-PRS resources to minimize resource collision or mutual interference with other UEs requires further discussion and research.

FIG. 9 is a flowchart of a method for resource selection according to some embodiments of the present disclosure. The method is applicable to a terminal device, and may include the following step.

In step 910, the terminal device selects at least one SL-PRS resource from an SL-PRS resource set, wherein the SL-PRS resource is used to transmit an SL-PRS.

The SL-PRS resource set contains at least one resource used to transmit the SL-PRS.

In some embodiments, the terminal device randomly the selects at least one SL-PRS resource from the SL-PRS resource set. In some embodiments, an upper layer of the terminal device randomly selects the at least one SL-PRS resource from the SL-PRS resource set, wherein the upper layer refers to a layer above a physical layer, for example, a MAC layer.

In some embodiments, one SL-PRS resource is selected by the terminal device from the SL-PRS resource set, wherein the one SL-PRS resource is used for an initial transmission of the SL-PRS.

In some embodiments, a plurality of SL-PRS resources are selected by the terminal device from the SL-PRS resource set, wherein the plurality of SL-PRS resources contains one SL-PRS resource used for the initial transmission and at least one SL-PRS resource used for a retransmission.

In some embodiments, the SL-PRS resource used for the initial transmission is a first resource in the at least one SL-PRS resource, wherein the first resource refers to the resource at the most forward time-domain position in the at least one SL-PRS resource.

In some embodiments, a plurality of SL-PRS resources are selected, and the plurality of SL-PRS resources occupy a group of OFDM symbols at a same position across different time-domain units, alternatively, the plurality of SL-PRS resources occupy a group of OFDM symbols at neighboring positions across different time-domain units; wherein one time-domain unit contains at least one OFDM symbol group, each of the at least one OFDM symbol group containing at least one OFDM symbol. The time-domain unit may be a slot, or a subframe, or other time-domain units, the present disclosure does not limit such aspect. One time-domain unit contains 14 OFDM symbols.

In some embodiments, OFDM symbol groups contained in different time-domain units are the same, or alternatively, means of grouping the OFDM symbols in different time-domain units are the same. Exemplary, as illustrated in FIG. 10, one time-domain unit contains three OFDM symbol groups, wherein a first symbol group contains OFDM symbols with indexes 3 to 6, a second symbol group contains OFDM symbols with indexes 7 to 10, a third symbol group contains OFDM symbols with indexes 11 to 12, and each time-domain unit contains the three OFDM symbol groups illustrated in FIG. 10. It should be noted that FIG. 10 merely illustrates an exemplary schematic of the OFDM symbol group contained in some type of time-domain unit, and the present disclosure does not limit the OFDM symbol group contained in the time-domain unit. For example, one time-domain unit may contain one or a plurality of OFDM symbol groups.

The expression “symbol groups at the same position” indicates that the positions across time-domain units occupied by the OFDM symbols contained in a symbol group are the same. The OFDM symbol groups occupied in each time-domain unit may be one or a plurality, which is not limited in the present disclosure. For example, as illustrated in FIG. 10, a selected resource occupies a first symbol group within a time-domain unit 1, therefore, the selected resource also occupies the first symbol group within a time-domain unit 2. As another example, a selected resource occupies a first symbol group and a second symbol group within a time-domain unit 1, therefore, the selected resource also occupies the first symbol group and a second symbol group within a time-domain unit 2. The time-domain unit 1 and the time-domain unit 2 are different time-domain units, and may or may not be neighboring time-domain units.

In some embodiments, a plurality of SL-PRS resources may be selected. The plurality of selected resources occupy the symbol group at a same position cross different time-domain units with a same offset. In this way, the number of bits used indicate signaling of the SL-PRS resources is minimized.

In a case where no other OFDM symbols and/or OFDM symbol groups are present between two OFDM symbol groups, the two OFDM symbol groups are referred to as symbol groups at neighboring positions. Within a plurality of OFDM symbol groups, in a case where no other symbol groups are present between an i^{th} symbol group and an (i+1)^{th} symbol group, the plurality of OFDM symbols are referred to as symbol groups at neighboring positions, wherein i is an integer greater than 0. As illustrated in FIG. 10, a first symbol group and a second symbol group are referred to as neighboring symbol groups, the second symbol group and a third symbol group are referred to as neighboring symbol groups. The first symbol group, the second symbol group, and the third symbol group are collectively referred to as neighboring symbol groups. However, the first symbol group and the third symbol group are not neighboring symbol groups.

The OFDM symbol groups at neighboring positions occupied by a plurality of SL-PRS resources across different time-domain units refer to the OFDM symbol groups at neighboring positions occupied by the SL-PRS resources in the same time-domain unit among the plurality of SL-PRS resources. The OFDM symbol groups at neighboring positions occupied by the plurality of SL-PRS resources in the same time-domain unit may or may not be the same, which is not limited in the present disclosure. For example, as illustrated in FIG. 10, in the plurality of SL-PRS resources, the OFDM symbol groups occupied by the SL-PRS in a time-domain unit 1 are referred to as a first symbol group and a second symbol group, and the OFDM symbol groups occupied by the SL-PRS resource in a time-domain unit 2 are referred to as the second symbol group and a third symbol group. As another example, in the plurality of SL-PRS resources, the OFDM symbol groups occupied by the SL-PRS in a time-domain unit 1 are referred to as a first symbol group and a second symbol group, and the OFDM symbol groups occupied by the SL-PRS resource in a time-domain unit 2 are referred to as the first symbol group and the second symbol group.

In some embodiments, a time-domain interval between two neighboring selected SL-PRS resources is greater than 0 and less than or equal to a fourth threshold. The time-domain interval refers to an interval between time-domain units, i.e., the number of time-domain units between the time-domain units occupied by the two neighboring selected SL-PRS resources. “Two neighboring resources” indicates that no third SL-PRS resource is present between the two neighboring resources. For example, the first SL-PRS resource and the second SL-PRS resource are referred to as two neighboring resources, wherein the first SL-PRS resource occupies the first time-domain unit 1, the second SL-PRS resource occupies the second time-domain unit 2, and the number of time-domain units between the first time-domain unit 1 and the second time-domain unit 2 is referred to as the time-domain interval.

In some embodiments, the fourth threshold may be configured by the network, pre-configured or predefined, which is not limited in the present disclosure. Exemplary, the fourth threshold value is 32 indicates that the time-domain interval between two neighboring selected resources is greater than 0 and less than or equal to 32.

In some embodiments, the plurality of SL-PRS resources are indicated via SCI, and the SCI is used to indicate configuration information for the SL-PRS.

The terminal device selects at least one SL-PRS resource from an SL-PRS resource set as the SL-PRS resource set contains a relatively large number of candidate resources, such that resource collision or mutual interference with other terminal devices is effectively reduced.

Regarding the SL-PRS resource set, the embodiments of the present disclosure have provided several methods for resource selection under different SL-PRS resource sets.
1. The SL-PRS resource set contains all of SL-PRS resource configured or pre-configured within a resource pool, or the SL-PRS resource set contains SL-PRS resources within a first time-domain range that are configure or pre-configured within a resource pool.

The first time-domain range refers to a time-domain range extending from a current time-domain unit to a last time-domain unit preceding a remaining latency of the SL-PRS. The remaining latency refers a remaining time-domain unit in which the SL-PRS still needs to be transmitted, or a remaining time-domain range with positioning requirements. The remaining latency is determined based on services applied by the SL-PRS. For example, in a case where the service terminates after 10 time-domain units, the remaining latency of the SL-PRS is the 10 time-domain units, and the first time-domain range is the time-domain range that extends from the current time-domain unit to the ninth time-domain unit.

The resource pool refers to a collection of resources, the resource pool may be the resource pool used for sidelink transmission, or any resource pool containing the SL-PRS resources.

The SL-PRS resource refers to a time-domain resource in a time-domain unit used for SL-PRS transmission, and the SL-PRS resource includes the following characteristics:
an SL-PRS resource ID;
a comb size of the SL-PRS resource and an RE offset transmitted within the SL-PRS;
a start OFDM symbol within a slot of the SL-PRS resource and the number of consecutive OFDM symbols occupied by the SL-PRS resource; and
an RB occupied by the SL-PRS resource during the OFDM symbols.

The SL-PRS resource ID is used to uniquely identify the SL-PRS resource. The comb size of the SL-PRS refers to an interval between REs occupied by the SL-PRS, and the RE offset indicates a position of a RE occupied by the SL-PRS resource during the OFDM symbols.

The SL-PRS resources within the resource pool may be configured by the network or pre-configured. Exemplary, a network device transmits configuration/pre-configured information to the terminal device. The configuration/pre-configured information may explicitly indicate all the characteristics of each SL-PRS resource or only explicitly indicate part of the characteristics of each SL-PRS resource. In an exemplary case where the configuration/pre-configured information only indicates part of the characteristics such as the SL-PRS resource ID, the comb size of the SL-PRS resource and the RE offset transmitted within the SL-PRS, and the start OFDM symbol within a slot of the SL-PRS resource and the number of consecutive OFDM symbols occupied by the SL-PRS resource, and does not indicate the RB occupied by the SL-PRS resource. In this case, RBs occupied by each configured/pre-configured SL-PRS resource are the same as RBs configured within the resource pool. The RBs configured within the resource pool are considered as the RBs occupied by the resource pool.

In this case, the terminal device randomly selects at least one SL-PRS resource from the SL-PRS resource set. For example, in a case where N+1 represents the number of transmissions the SL-PRS needs to be transmitted including an initial transmission and N retransmissions, and remaining resources are present in the SL-PRS resource set, the terminal device selects the N+1 SL-PRS resources from the SL-PRS resource set, wherein the first SL-PRS resource in the N+1 SL-PRS resources is used as an initial transmission resource for the SL-PRS, other resources are used as retransmission resources for the SL-PRS, wherein N is a natural number.

In some embodiments, the N+1 SL-PRS resources may be indicated via SCI, and the SCI is used to indicate configuration information.

In some embodiments, a time-domain interval between two neighboring SL-PRS resources among the N+1 SL-PRS resources is greater than 0 and less than or equal to a fourth threshold.

In some embodiments, a plurality of resource may be selected, and the plurality of SL-PRS resources occupy a group of OFDM symbols at a same position across different time-domain units, alternatively, the plurality of SL-PRS resources occupy a group of OFDM symbols at neighboring positions across different time-domain units. In this way, an overhead for an indication signaling may be reduced.

In some embodiments, in a case where the number of SL-PRS resource within the SL-PRS resource set is less than N+1, all SL-PRS resources within the SL-PRS resource set are selected as resources for the SL-PRS.

According to the method, the number of candidate SL-PRS resources in the SL-PRS resource set is maximized, such that the possibility of resource collision between different terminal devices is reduced as much as possible.
2. The SL-PRS resource set contains part of SL-PRS resources configured or pre-configured within a resource pool, or the SL-PRS set contains part of SL-PRS resources within a first time-domain range that are configured or pre-configured within a resource pool.

Alternatively, the SL-PRS resource set is a subset of SL-PRS resources configured or pre-configured within the resource pool, or the SL-PRS resource set is a subset of SL-PRS resources within a first time-domain that are configured or pre-configured within a resource pool.

In this case, the terminal device randomly selects at least one SL-PRS resource from the SL-PRS resource set. For example, in a case where N+1 is the number of transmissions the SL-PRS needs to be transmitted including an initial transmission and N retransmissions, and remaining resources are present in the SL-PRS resource set, the terminal device selects the N+1 SL-PRS resources from the SL-PRS resource set, wherein the first SL-PRS resource in the N+1 SL-PRS resources is used as an initial transmission resource for the SL-PRS, other resources are used as retransmission resources for the SL-PRS, wherein N is a natural number.

In some embodiments, the N+1 SL-PRS resources may be indicated via SCI, and the SCI is used to indicate configuration information.

In some embodiments, a time-domain interval between two neighboring SL-PRS resources among the N+1 SL-PRS resources is greater than 0 and less than or equal to a fourth threshold.

In some embodiments, the number of OFDM symbols occupied by the SL-PRS resources in the SL-PRS resource set is greater than or equal to a first threshold, and a comb size of the SL-PRS resources is less than or equal to a second threshold.

In some embodiments, the first threshold and the second threshold are determined by a transmitter device for the SL-PRS and/or a receiver device for the SL-PRS. For example, the first threshold and the second threshold are determined based on a positioning requirement of the transmitter device for the SL-PRS and/or a positioning requirement of the receiver device for the SL-PRS, wherein the positioning requirement may include a positioning accuracy requirement, a positioning range requirement, and the like.

In some embodiments, an effective comb size of the SL-PRS resources in the SL-PRS resource set is greater than or equal to a third threshold, wherein the effective comb size is a product of a comb size of the SL-PRS resources and the number of OFDM symbols occupied by the SL-PRS.

In some embodiments, the third threshold may be determined using the same method used to determine the first threshold and/or the second threshold.

Via the first threshold and the second threshold, or the third threshold, the SL-PRS resources configured or pre-configured within the resource pool that do not meet the positioning requirements may be excluded from a candidate resource set, thereby improving the positioning accuracy.

In some embodiments, the SL-PRS resources in the SL-PRS resource set occupy a group of OFDM symbols at a same position across different time-domain units, wherein one time-domain unit contains at least one OFDM symbol group, each of the at least one OFDM symbol group containing at least one OFDM symbol. For example, as illustrated in FIG. 10, the SL-PRS within the SL-PRS resource set occupies a first symbol group across different time-domain units, more specifically, the SL-PRS resources within the SL-PRS resource set occupy the first symbol group in a time-domain unit 1 and the first symbol group in a time-domain unit 2.

In some embodiments, the SL-PRS resources within the SL-PRS resource set occupy a group of OFDM symbols at neighboring positions across different time-domain units, wherein one time-domain unit contains at least one OFDM symbol group, each of the at least one OFDM symbol group containing at least one OFDM symbol.

According to the method, the terminal device may exclude the SL-PRS resources configured or pre-configured within the resource pool that do not meet the positioning requirement from the SL-PRS resource subset, thereby ensuring a positioning accuracy. Additionally, the SL-PRS resources within the SL-PRS resource set occupy OFDM symbol groups at a same position across different time-domain units, or occupy OFDM symbol groups at neighboring positions across different time-domain units, overhead for indication signaling may also be reduced.

### 3. Determining the SL-PRS Resource Set Based on Resource Sensing

3.1 Selecting at least one SL-PRS resource from the SL-PRS resource set.

The SL-PRS resource set refers to the SL-PRS resource set determined based on resource sensing, wherein the resource set contains all SL-PRS resources in the resource pool that are configured or pre-configured except SL-PRS resources that have been excluded, or the resource set contains all SL-PRS resources in the resource pool that are configured or pre-configured within a first time-domain range other than SL-PRS resources that have been excluded.

The SL-PRS resources that have been excluded contain SL-PRS resources that have been occupied and SL-PRS resources that have been reserved.

In some embodiments, the terminal device transmits the SL-PRS resource set following resource sensing, wherein the SL-PRS resource set is determined based on resource sensing.
3.2 Preferentially selecting at least one SL-PRS resource from a first resource subset of the SL-PRS resource set, wherein no excluded SL-PRS resources are present on OFDM symbols occupied by the SL-PRS resources contained in the first resource subset.

In some embodiments, as the SL-PRS is mapped onto the RE of the OFDM symbol using a comb-tooth structure, and different SL-PRS resources have different RE offsets, one OFDM symbol may contain one or more SL-PRS resources For example, one OFDM symbol may contain three SL-PRS resources with a comb-tooth size 3 and RE offsets 0, 1, and 2 respectively.

In some embodiments, that “no excluded SL-PRS resources are present on OFDM symbols occupied by the SL-PRS resources contained in a first resource subset” indicates that the SL-PRS on the OFDM symbols have not been occupied or reserved.

In this case, the terminal device randomly selects the at least one SL-PRS resource from the SL-PRS resource set. For example, in a case where N+1 is the number of transmissions the SL-PRS needs to be transmitted including an initial transmission and N retransmissions, and remaining resources are present in the SL-PRS resource set, the terminal device selects the N+1 SL-PRS resources from the SL-PRS resource set, wherein the first SL-PRS resource in the N+1 SL-PRS resources is used as an initial transmission resource for the SL-PRS, other resources are used as retransmission resources for the SL-PRS, wherein N is a natural number.

In some embodiments, the N+1 SL-PRS resources may be indicated via SCI, and the SCI is used to indicate configuration information.

In some embodiments, a time-domain interval between two neighboring SL-PRS resources among the N+1 SL-PRS resources is greater than 0 and less than or equal to a fourth threshold.

In some embodiments, a plurality of resources may be selected, and the plurality of SL-PRS resources occupy a group of OFDM symbols at a same position across different time-domain units, alternatively, the plurality of SL-PRS resources occupy a group of OFDM symbols at neighboring positions across different time-domain units.

In some embodiments, in a case where the number of selected SL-PRS resources from the first resource subset is less than a first value, additional at least one SL-PRS resource is selected from a second resource subset, wherein the second resource subset contains SL-PRS resources other than the first resource subset of the SL-PRS resource set.

The first value is the number of SL-PRS resources needed to transmit the SL-PRS. For example, in a case where the SL-PRS needs one initial transmission and N retransmission, the first value is N+1. Exemplary, in a case where the number of SL-PRS resources contained in the first SL-PRS resource subset is less than N+1, the SL-PRS resources contained in the first SL-PRS resource subset are used as resources for transmitting the SL-PRS, and additional SL-PRS resources are selected from the second SL-PRS resource subset.

By the method, no other SL-PRS resources are present on the OFDM symbols occupied by the selected SL-PRS resources, reducing the possibility of frequency-division multiplexing of SL-PRS resources with other terminal devices, thereby reducing the impact of in-band leakage.
3.3. Selecting at least one SL-PRS resource from a third resource subset from the SL-PRS resource set, wherein the third resource subset is determined based on the number of excluded SL-PRS resources on an OFDM symbol.

As described in the method 3.2, in a case where no SL-PRS resources in the SL-PRS resources within the resource pool satisfy the conditions of the first resource subset, or the number of SL-PRS resources within the first resource subset does not satisfy the requirements of the SL-PRS, the issue of in-band leakage remains, and the method 3.2 has provided a solution in this regard.

In some embodiments, the third resource subset may be determined by step 1 to step 3.

In step 1, the third resource subset is initialized, and the number of excluded SL-PRS resources on the OFDM symbols occupied by the SL-PRS resources in the third resource subset is less than or equal to i, wherein i is an integer greater than or equal to 0.

In step 2, the SL-PRS resources are selected from the third resource subset.

In step 3, in a case where no SL-PRS resources remain in the third resource subset, and the number of selected resources is less than the first value, i is set to be equal to (i+1), and the steps of selecting the SL-PRS resource from the third resource subset is repeatedly performed until the number of selected SL-PRS resources reaches the first value.

Exemplary, regarding the first value N+1, step 1 to step 3 may be implemented as follows:

Let i=0, in this case, the SL-PRS resources contained in the third resource subset are the same as the SL-PRS resources contained in the first resource subset; both are SL-PRS resources on which no excluded SL-PRS resources are present on the OFDM symbols.

Selecting the SL-PRS resources from the third resource subset.

The resource selection continues in a case where no SL-PRS resources remain in the third resource subset, and the number of selected resources is less than N+1, i is set to be equal to (i+1=1). In this case, the SL-PRS resources contained in the third subset are SL-PRS resources on which only one excluded SL-PRS resource is present on the OFDM symbols.

The resource selection continues in a case where no SL-PRS resources remain in the third resource subset, and the number of selected resources is still less than N+1, i is set to be equal to (i+1=2). In this case, the SL-PRS resources contained in the third subset are SL-PRS resources on which only two excluded SL-PRS resources are present on the OFDM symbols.

The resource selection stops once the number of selected SL-PRS resources reaches N+1 or no remaining resources are present in the resource pool.

In comparison to the method 3.2, the method better reduces the impact of in-band leakage, but increases implementation complexity.
3.4 How to select resources in the methods 3.1, 3.2, and 3.3

In some embodiments, the at least one SL-PRS resource is randomly selected upon resource selection from the first resource subset, the second resource subset, and/or the third resource subset.

In some embodiments, in a case where excluded SL-PRS resources are present on an OFDM symbol group upon selection of the SL-PRS resource on any one OFDM symbol group, SL-PRS resources with a largest frequency-domain separation from the excluded SL-PRS resources are preferentially selected.

The frequency-domain separation between the SL-PRS resources may be determined based on two RE offsets of the SL-PRS resources. The greater the difference between RE offsets, the greater the frequency-domain separation.

Exemplary, one OFDM symbol contains four SL-PRS resources with RE offsets 0, 1, 2, and 3. In a case where the SL-PRS resource with the RE offset 0 is occupied, the SL-PRS resource with the largest frequency-domain separation from the SL-PRS resource is the SL-PRS resource with the RE offset 3. In a case where the SL-PRS resource with the RE offset 2 is occupied, the SL-PRS resource with the largest frequency-domain separation from the SL-PRS resource is the SL-PRS resource with the RE offset 0.

The method may reduce a risk of in-band leakage to some extent. Additionally, the method reduces the complexity of resource selection in comparison to the method 3.3.

### 4. Indicating the SL-PRS Resources by an Upper Layer

In some embodiments, the at least one SL-PRS resource is selected from the SL-PRS resources indicated by the upper layer.

In some embodiments, the upper layer refers to the layer above a medium access control (MAC) layer. For example, the upper layer may be a sidelink positioning protocol (SLPP) layer.

The upper layer may accurately select a suitable SL-PRS resource set, such that the selected SL-PRS resources may ensure the positioning accuracy.

Hereinafter are embodiments of the apparatus of the present disclosure, which may be configured to implement the method embodiments of the present disclosure. For details not disclosed in the apparatus embodiments of the present disclosure, reference may be made to the method embodiments of the present disclosure.

FIG. 11 is a schematic block diagram of an apparatus for resource selection according to some embodiments of the present disclosure. The apparatus has a function to implement the method for resource selection, and the function may be implemented via hardware, or via hardware executing corresponding software. The apparatus may be the terminal device as described above, or implemented within the terminal device. As illustrated in FIG. 11, the apparatus 1100 may include: a selecting module 1110.

The selecting module 1110 is configured to select at least one SL-PRS resource from an SL-PRS resource set, wherein the SL-PRS resource is used to transmit an SL-PRS.

In some embodiments, the SL-PRS resource set contains all SL-PRS resources configured or pre-configured within a resource pool; or the SL-PRS resource set contains the SL-PRS resources with a first time-domain range that are configured or pre-configured within a resource pool.

In some embodiments, the SL-PRS resource set contains part of the SL-PRS resources configured or preconfigured within a resource pool; or the SL-PRS resource set contains part of the SL-PRS resources within a first time-domain range that are configured or pre-configured within a resource pool.

In some embodiments, the first time-domain range extends from a current time-domain unit to a last time-domain unit preceding a remaining latency of the SL-PRS.

In some embodiments, the number of OFDM symbols occupied by the SL-PRS resources in the SL-PRS resource set is greater than or equal to a first threshold, and a comb size of the SL-PRS resources is less than or equal to a second threshold; or an effective comb size of the SL-PRS resources in the SL-PRS resource set is greater than or equal to a third threshold, wherein the effective comb size is a product of a comb size of the SL-PRS resources and the number of OFDM symbols occupied by the SL-PRS; or the SL-PRS resources in the SL-PRS resource set occupy a group of OFDM symbols at a same position across different time-domain units, wherein one time-domain unit contains at least one OFDM symbol, each of the at least one OFDM symbol group containing at least one OFDM symbol; or the SL-PRS resources in the SL-PRS resource set occupy a group of OFDM symbols at neighboring positions across different time-domain units, wherein one time-domain unit contains at least one OFDM symbol group, each of the at least one OFDM symbol group containing at least one OFDM symbol.

In some embodiments, the selecting module 1110 is configured to randomly select at least one SL-PRS resource from the SL-PRS resource set.

In some embodiments, the SL-PRS resource set is determined based on resource sensing.

In some embodiments, the selecting module 1110 is configured to randomly select at least one SL-PRS resource from the SL-PRS resource set.

In some embodiments, the selecting module 1110 is configured to preferentially select the at least one SL-PRS resource from a first resource subset of the SL-PRS resource set, wherein no excluded SL-PRS resources are present on the OFDM symbols occupied by the SL-PRS resource contained in the first resource subset.

In some embodiments, the selecting module 1110 is configured to select additional at least one SL-PRS resource from a second resource subset in a case where the number of SL-PRS resources from the first resource subset is less than a first value, wherein a second resource subset contains SL-PRS resources other than the first resource subset of the SL-PRS resource set.

In some embodiments, the selecting module 1110 is configured to select the at least one SL-PRS resource from a third resource subset from the SL-PRS resource set, wherein the third resource subset is determined based on the number of excluded SL-PRS resources on an OFDM symbol.

In some embodiments, the selecting module 1110 is configured to initialize the third resource subset, wherein the number of excluded SL-PRS resources on the OFDM symbols occupied by the SL-PRS resources in the third resource subset is less than or equal to i, wherein i is an integer greater than or equal to 0; select the SL-PRS resource from the third resource subset; and set i to be equal to (i+1), and perform repeatedly the step of selecting the SL-PRS resource from the third resource subset, in a case where no remaining SL-PRS resources are present in the third resource subset and the number of SL-PRS resources is less than a first value, until the number of selected SL-PRS resources reaches the first value.

In some embodiments, in a case where excluded SL-PRS resources are present on an OFDM symbol group upon selection of the SL-PRS resource on any one OFDM symbol group, SL-PRS resources with a largest frequency-domain separation from the excluded SL-PRS resources are preferentially selected.

In some embodiments, a plurality of SL-PRS resources are selected, wherein the plurality of SL-PRS resources include one SL-PRS resource used for an initial transmission and at least one SL-PRS resource used for a retransmission.

In some embodiments, a plurality of SL-PRS resource are selected, wherein the plurality of SL-PRS resources occupy a group of OFDM symbols at a same position across different time-domain units, or the plurality of SL-PRS resources occupy a group of OFDM symbols at neighboring positions across different time-domain units; wherein one time-domain unit contains at least one OFDM symbol group, each of the at least one OFDM symbol group containing at least one OFDM symbol.

In some embodiments, a time-domain interval between two neighboring selected SL-PRS resources is greater than 0 and less than or equal to a fourth threshold.

The terminal device selects at least one SL-PRS resource from an SL-PRS resource set as the SL-PRS resource set contains a relatively large number of candidate resources, such that resource collision or mutual interference with other terminal devices is effectively reduced.

It should be noted that the apparatus according to the above embodiments is only described by way of example in terms of the division of functional modules when implementing its functions. In practice, the functions may be allocated to be completed by different functional modules as needed. That is, the device or apparatus may be designed to have different functional modules to complete part or all of the functions as described above.

Regarding the apparatus described in the above embodiments, the specific details regarding each module performing operations have been given in detail in the above method embodiments of the present disclosure, which are not elaborated herein. For details not disclosed in the apparatus embodiments of the present disclosure, references may be made to the method embodiments of the present disclosure.

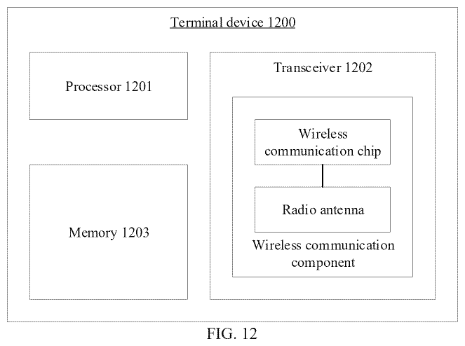

FIG. 12 is a schematic structural diagram of a terminal device according to some embodiments of the present disclosure. The terminal device 1200 includes: a processor 1201, a receiver 1202, and a memory 1203.

The processor 1201 includes one or more processing cores, and is configured to execute various functional applications and information processing by running software programs and modules.

The transceiver 1202 may include a transmitter and a receiver. For example, the transmitter and the receiver may implemented as a same wireless communication component. The wireless communication component may include a wireless communication chip and a radio frequency antenna.

The memory 1203 may be communicably connected to the processor 1201 and the transceiver 1202.

The memory 1203 may be configured to store one or more computer programs, and the processor 1201 is configured to run the one or more computer programs to implement various procedures of the above method embodiments.

In some exemplary embodiments, the processor 1201 is configured to select at least one SL-PRS resource from the SL-PRS resource set, wherein the SL-PRS resource is used to transmit an SL-PRS.

For details not disclosed in the apparatus embodiments of the present disclosure, references may be made to the method embodiments of the present disclosure, which will not be elaborated herein.

Furthermore, the memory may be implemented in any type of transitory or non-transitory storage device or a combination thereof, and the transitory or non-transitory storage device includes but is not limited to: a magnetic disk or optical disk, an electrical erasable programmable read-only memory (EEPROM), an erasable programmable read-only memory (EPROM), a static random-access memory (SRAM), a read-only memory (ROM), a magnetic memory, a flash memory, and a programmable read-only memory (PROM).

Some embodiments of the present disclosure further provide a computer readable storage medium storing one or more computer programs therein. The one or more computer programs when loaded and run by a processor, cause the processor to perform the method for establishing a communication connection involving the terminal device, or the method for establishing a communication connection involving the wireless access device. Optionally, the computer-readable storage medium includes: a ROM, a RAM, a solid state drive (SSD), an optical disk, or the like. The RAM may include a resistance random-access memory (ReRAM) and a dynamic random-access memory (DRAM).

Some embodiments of the present disclosure further provide a chip. The chip includes programmable logic circuitry and/or one or more computer instructions, wherein the chip, when running a processor, is configured to perform the method for resource selection.

Some embodiments of the present disclosure further provide a computer program product or computer program. The computer program product or computer program includes one or more computer instructions, wherein the one or more computer instructions are stored in the computer readable storage medium. The one or more computer instructions, when loaded and executed by a processor from the computer-readable storage medium, cause the processor to perform the method for resource selection.

It should be understood that the term “indicate” in the embodiments of the present disclosure means the direct indication, indirect indication, or an associated relationship. For example, A indicating B means that A directly indicates B, e.g., B is acquired via A; or means that A indirectly indicates B, e.g., A indicates C and B is acquired via C; or means that A and B are associated.

In the description of the embodiments of the present disclosure, the term “corresponding” may indicate a direct or indirect correspondence between two items, or an association relationship between the two items, or a relationship between indication and being indicated, configuration and being configured, and the like.

In some embodiments of the present disclosure, the term “predefined” is implemented by pre-storing corresponding codes, tables, or other means that may be defined to indicate related message in devices (including, for example, terminal devices and network devices), and the present disclosure does not limit the specific implementation thereof. For example, the term “predefined” refers to being “defined” in a protocol.

In some embodiments of the present disclosure, the term “protocol” may indicate a standard protocol within the field of communication, for example, the term may include an LTE protocol, an NR protocol or related protocols used in future communication systems, which is not limited in the present disclosure.

The term “a plurality” herein means two or more. The term “and/or” describes the association relationship between the associated objects, and indicates that three relationships may be present. For example, the phrase “A and/or B” means (A), (B), or (A and B). The symbol “/” generally indicates an “or” relationship between the associated objects.

Reference herein to “greater than or equal to” may indicate greater than or equal to or just greater than, and “less than or equal to” may indicate less than or equal to or just less than.

Additionally, serial numbers of the processes described herein only show an exemplary possible sequence of performing the processes. In some other embodiments, the processes may also be performed out of the numbering sequence, for example, two processes with different serial numbers are performed simultaneously, or two processes with different serial numbers are performed in reverse order to the illustrated sequence, which is not limited in the present disclosure.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements and the like, made within the spirit and principle of the present disclosure should fall within the protection scope of the present disclosure.

1. A method for resource selection, performed by a terminal device, the method comprising:
selecting at least one sidelink positioning reference signal (SL-PRS) resource from an SL-PRS resource set, wherein the SL-PRS resource is used to transmit an SL-PRS.

2. The method according to claim 1, wherein:
the SL-PRS resource set contains all SL-PRS resources configured or pre-configured within a resource pool; or
the SL-PRS resource set contains SL-PRS resources within a first time-domain range that are configured or pre-configured within a resource pool.

3. The method according to claim 2, wherein the first time-domain range extends from a current time-domain unit to a last time-domain unit prior to a remaining latency of the SL-PRS.

4. The method according to claim 2, wherein selecting the at least one SL-PRS resource from the SL-PRS resource set comprises:
randomly selecting at least one SL-PRS resource from the SL-PRS resource set.

5. The method according to claim 1, wherein the SL-PRS resource set is determined based on resource sensing.

6. The method according to claim 5, wherein selecting the at least one SL-PRS resource from the SL-PRS resource set comprises:
randomly selecting at least one SL-PRS resource from the SL-PRS resource set.

7. The method according to claim 5, wherein selecting the at least one SL-PRS resource from the SL-PRS resource set comprises:
preferentially selecting the at least one SL-PRS resource from a first resource subset of the SL-PRS resource set, wherein no excluded SL-PRS resources are present on OFDM symbols occupied by the SL-PRS resources contained in the first resource subset.

8. The method according to claim 7, wherein in a case where excluded SL-PRS resources are present on an OFDM symbol group upon selection of the SL-PRS resource on any one OFDM symbol group, SL-PRS resources with a largest frequency-domain separation are preferentially selected from the excluded SL-PRS resources.

9. The method according to claim 1, wherein a plurality of SL-PRS resources are selected, wherein the plurality of SL-PRS resources comprise one SL-PRS resource used for an initial transmission and at least one SL-PRS resource used for a retransmission.

10. The method according to claim 1, wherein a time-domain interval between two neighboring selected SL-PRS resources is greater than 0 and less than or equal to a fourth threshold.

11. A terminal device, comprising:
a processor and a memory, wherein the memory stores at least one program, and the processor is configured to call and run the at least one program to: select at least one sidelink positioning reference signal (SL-PRS) resource from an SL-PRS resource set, wherein the SL-PRS resource is used to transmit an SL-PRS.

12. The terminal device according to claim 11, wherein:
the SL-PRS resource set contains all of SL-PRS resources configured or pre-configured within a resource pool; or
the SL-PRS resource set contains SL-PRS resources within a first time-domain range that are configured or pre-configured within a resource pool.

13. The terminal device according to claim 12, wherein the first time-domain range extends from a current time-domain unit to a last time-domain unit prior to a remaining latency of the SL-PRS.

14. The terminal device according to claim 12, wherein the memory stores at least one program, and the processor is configured to call and run the at least one program to: randomly select at least one SL-PRS resource from the SL-PRS resource set.

15. The terminal device according to claim 11, wherein the SL-PRS resource set is determined based on resource sensing.

16. The terminal device according to claim 15, wherein the memory stores at least one program, and the processor is configured to call and run the at least one program to: randomly select at least one SL-PRS resource from the SL-PRS resource set.

17. The terminal device according to claim 15, wherein the memory stores at least one program, and the processor is configured to call and run the at least one program to: preferentially select the at least one SL-PRS resource from a first resource subset of the SL-PRS resource set, wherein no excluded SL-PRS resources are present on OFDM symbols occupied by the SL-PRS resources contained in the first resource subset.

18. The terminal device according to claim 11, wherein a plurality of SL-PRS resources are selected, wherein the plurality of SL-PRS resources comprise one SL-PRS resource used for an initial transmission and at least one SL-PRS resource used for a retransmission.

19. The terminal device according to claim 11, wherein a time-domain interval between two neighboring selected SL-PRS resources is greater than 0 and less than or equal to a fourth threshold.

20. A chip, comprising:
programmable logic circuitry and/or one or more program instructions;
wherein the chip, when running on a device, is configured to select at least one sidelink positioning reference signal (SL-PRS) resource from an SL-PRS resource set, wherein the SL-PRS resource is used to transmit an SL-PRS.
